(19) United States
(12) Patent Application Publication
(10) Pub. No.: US 2007/0239659 A1
(43) Pub. Date: Oct. 11, 2007

(54) Query generator

(75) Inventors: Paolo Fragapane, Bristol (GB); Natascha Kearsey, Bristol (GB); Christopher Evans, Bristol (GB); Martin Hogg, Bristol (GB)

Correspondence Address: BINGHAM MCCUTCHEN, LLP, 2020 K STREET, NW, BOX IP, WASHINGTON, DC, 20006, US

(73) Assignee: Oracle International Corporation

(21) Appl. No.: 11/392,777

(22) Filed: Mar. 30, 2006

(51) Int. Cl. G06F 17/30

(52) U.S. Cl. 707/2

(57) ABSTRACT

A query generator for generating a query for retrieving a desired set of data from a relational database is disclosed. The query generator is adapted to: a) receive an input query adapted to retrieve a superset of the desired set of data from the database; b) analyse a default filters table comprising one or more filter application criteria, each associated with a default filter condition that refers to data contained in the superset of data; and c) for each filter application criterion that is satisfied, modify the input query in accordance with the associated default filter condition to produce an output query adapted to retrieve the desired set of data only.

The present invention relates to a method for generating queries and to a query generator, in particular for use with relational databases.

It is common for a database administrator to define a report in the form of a Structured Query Language (SQL) statement, which when executed will retrieve desired data from a database and display it to a user in a desired format. For example, a company that makes a range of products may store defect data in a set of database tables. The company's managers for each of the various products will want to closely track the status of defects for their particular product. However, a given product manager will be much less interested in defects for other products that he is not responsible for. Thus, the defects will likely be monitored using a series of reports, each showing details of interest to a particular product manager.

In particular, a typical solution is for the database administrator to define a series of reports, each of which contains a filter to restrict the data retrieved to only the product of interest for each particular product manager. For example, the filter may act to restrict data retrieved to only those items where the “PRODUCT_NAME” column of a “PRODUCTS” table contains a specific value.

However, this solution carries with it various problems. In particular one report is required in the above example for each product which the company manufactures, and this has an obvious effect on the effort and cost required to build the reports and to maintain them. Furthermore, it represents a rather inflexible solution since individual users cannot vary the data that they see as a result of running their report.

In accordance with one aspect of the present invention, there is provided a query generator for generating a query for retrieving a desired set of data from a relational database, wherein the query generator is adapted to:

a) receive an input query adapted to retrieve a superset of the desired set of data from the database;

b) analyse a default filters table comprising one or more filter application criteria, each associated with a default filter condition that refers to data contained in the superset of data; and

c) for each filter application criterion that is satisfied, modify the input query in accordance with the associated default filter condition to produce an output query adapted to retrieve the desired set of data only.

In accordance with a second aspect of the present invention there is provided a method for generating a query for retrieving a desired set of data from a relational database, the method comprising:

a) receiving an input query adapted to retrieve a superset of the desired set of data from the database;

b) analysing a default filters table comprising one or more filter application criteria, each associated with a default filter condition that refers to data contained in the superset of data; and

c) for each filter application criteria that is satisfied, modifying the input query in accordance with the default filter condition to produce an output query adapted to retrieve the desired set of data only.

Hence, by analysing the default filters table before executing the input query, it is possible to modify this in accordance with one or more default filter conditions such that when the report is run only the desired set of data is presented to the user. Individual users may specify their own filter conditions and criteria to suit their purposes. For example, a product manager may specify a filter application criterion that whenever he is the user and the input query refers to a “PRODUCTS” table an associated default filter condition specifying a specific value of “PRODUCT_NAME” is to be applied. Thus, the abovementioned problems of the prior art are overcome.

Of course, the output query is normally then executed on the database, thereby retrieving the desired set of data.

The input query and output query are normally both SQL queries. Alternatively, a different query language such as Multidimensional Expressions (MDX) from Microsoft could be used, or the inputs and outputs could be in the form of an abstracted programmatic object model.

The desired set of data may be stored in more than one table in the database.

The default filters table may be stored in the database. Alternatively, in a different type of persistent store, such as an XML file, text file or binary file. It could even be stored transiently in a computer's volatile memory.

The filter application criteria may include the identification of a user, the geographical location of a user, and/or the time of execution of the query.

The desired set of data may include rows from one or more of the database tables containing data specified by the associated default filter condition.

The database may be located on a single computer, or it may be distributed over more than one computer.

In accordance with a third aspect of the present invention, a computer program comprises computer program code means adapted to perform the method of the second aspect of the invention when said program is run on a computer.

In accordance with a fourth aspect of the invention, a computer program product comprises program code means stored on a computer readable medium for performing the method of the second aspect of the invention when said program is run on a computer.

An embodiment of the invention will now be described with reference to the accompanying drawings, in which:

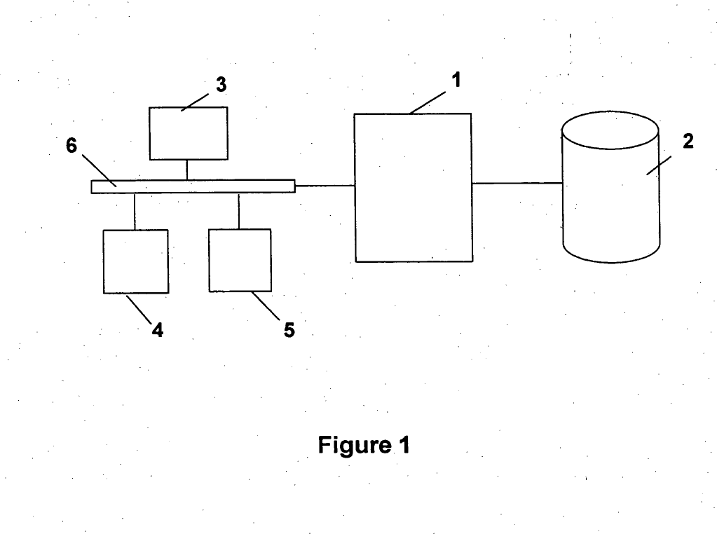

FIG. 1 shows a query generator system on which the invention may be implemented;

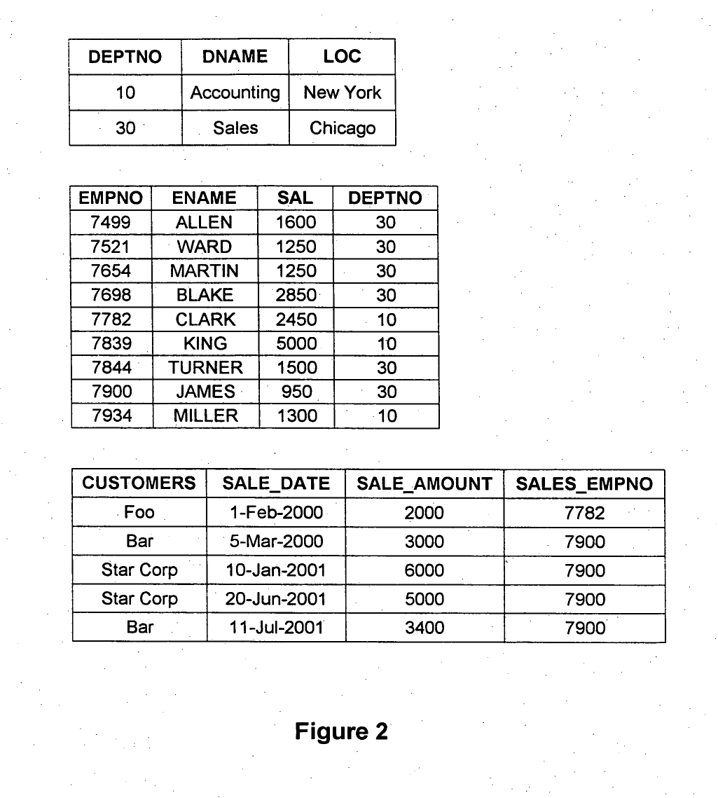

FIG. 2 shows a set of sample data tables within the database; and

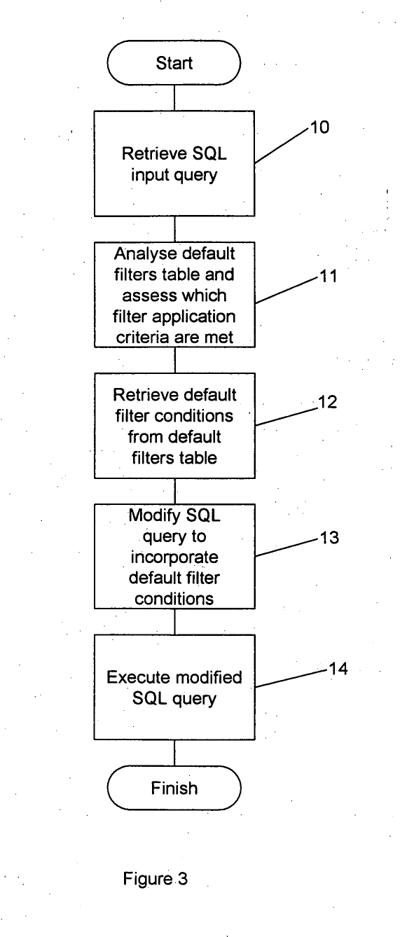

FIG. 3 shows a flow chart of the method performed by the invention.

FIG. 1 shows a server 1 which is connected to a database 2. The server 1 is operable to receive SQL queries from client computers 3, 4, 5 via a network 6. This network 6 may be any network, such as a local area network (LAN) or indeed it may be the Internet. Each of the client computers 3, 4, 5 runs report generator software that can construct the SQL query as set out below in response to user input and transmit the query over network 6 to the server 1. The server 1 then executes the received query and extracts the necessary data from database 2 and performs any necessary computations on it before returning the results over the network 6 to the respective client computer 3, 4 or 5, where it is displayed in a desired format to the user. Of course, the invention may be implemented using client computers running browser software and connected to a middle-tier server which carries out the majority of the processing necessary (including report and SQL generation) and which communicates with the database.

FIG. 2 shows a sample set of database tables upon which this invention could be operated. The skilled man will appreciate that although the following example is described in terms of database tables and columns, the invention could in fact be implemented in the context of a metadata layer above the database schema. As can be seen, FIG. 2 shows three tables; DEPT with columns DEPTNO, DNAME, LOC; EMP having columns EMPNO, ENAME, SAL, DEPTNO (where DEPTNO is a foreign key to DEPT); and SALES with columns CUSTOMER, SALE_DATE, SALE_AMOUNT, SALES_EMPNO (where SALES_EMPNO is a foreign key to EMP).

In this example, the Chief Executive Officer (CEO) of the company requires two reports. The first of these reports shows the salaries of employees by department along with a total value of all the salaries in each department. The SQL statement required to return the data for this report is:

SELECT D. DNAME, E. EMPNO, E. ENAME, E. SAL

FROM DEPT D, EMP E

WHERE D. DEPTNO=E. DEPTNO

ORDER BY D.DNAME

This statement retrieves the DNAME, EMPNO, ENAME and SAL columns from tables DEPT and EMP and joins the results from the two tables based on equivalent values of DEPTNO from each table. The results are then sorted by the DNAME value. Thus, the statement returns the following results:

Department: Accounting

| EMPNO | ENAME | SAL |
|---|---|---|
| 7782 | CLARK | 2450 |
| 7839 | KING | 5000 |
| 7934 | MILLER | 1300 |
| | Total: | 8750 |

Department: Sales

| EMPNO | ENAME | SAL |
|---|---|---|
| 7499 | ALLEN | 1600 |
| 7521 | WARD | 1250 |
| 7654 | MARTIN | 1250 |
| 7698 | BLAKE | 2850 |
| 7844 | TURNER | 1500 |
| 7900 | JAMES | 950 |
| | Total: | 9400 |

In order to format the results above into this format, some post-processing is generally performed by the query generator software, for example to group the results into individual tables for each department and to calculate the totals.

The second report required by the CEO shows details of sales made by each department. The SQL statement required to generate this report is:

SELECT D. DNAME, S. CUSTOMER, S. SALE_DATE, S. SALE_AMOUNT,

S. SALES_EMPNO

FROM DEPT D, EMP E, SALES S

WHERE D. DEPTNO=E. DEPTNO

AND S. SALES_EMPNO=E. EMPNO

ORDER BY D.DNAME

This statement retrieves the DNAME, CUSTOMER, SALE_DATE, SALE_AMOUNT and SALES_EMPNO columns from the DEPT, EMP and SALES tables by joining the three tables by equating the DEPTNO values in the EMP and DEPT tables and the EMPNO and SALES_EMPNO values in the EMP and SALES tables. The results are then sorted according to the value of DNAME. The statement thus returns the data shown in the following two tables:

Department: Accounting

| CUS- | | | |
|---|---|---|---|
| TOMER | SALE_DATES | SALE_AMOUNT | SALES_EMPNO |
| Foo | 1 Feb. 2000 | 2000 | 7782 |
| | Total: | 2000 | |

Department: Sales

| CUS- | | | |
|---|---|---|---|
| TOMER | SALE_DATES | SALE_AMOUNT | SALES_EMPNO |
| Bar | 5 Mar. 2000 | 3000 | 7900 |
| Star Corp | 10 Jan. 2001 | 6000 | 7900 |
| Star Corp | 20 Jun. 2001 | 5000 | 7900 |
| Bar | 11 Jul. 2001 | 3400 | 7900 |
| | Total: | 17400 | |

In order to format the results above into this format, some post-processing is generally performed by the query generator software, for example to group the results into individual tables for each department and to calculate the totals.

Whilst these reports suffice for the purposes of the CEO, the Department Managers may wish to see the same reports but by default, filtered for their departments only. One possible way that this problem could be solved using prior art techniques is to create six separate reports to cover the requirements of the CEO and each Department Manager. The six required reports would be:

Employee Report by Department (the original one for the CEO)

Employee Report for Accounting Department

Employee Report for Sales Department

Sales Report by Department (the original one for the CEO)

Sales Report for Accounting Department

Sales Report for Sales Department

As already mentioned, these reports would need to be maintained separately as the database evolved or as more information was required in each report.

A second alternative is to add a parameter called DEPARTMENT to each of the main reports. This would reduce the maintenance effort since only two basic reports are required. However, it would also mean that before anyone could run any report, they would need to specify the parameter values. This would not be popular with the CEO who now has to perform an extra interaction before seeing the information in the reports and also needs to note the correct value to specify.

For example, this second approach could be achieved for the first report that shows the salaries of the employees by defining the report in terms of the following SQL statement:

SELECT D.DNAME, E.EMPNO, E.ENAME, E.SAL

FROM DEPT D, EMP E

WHERE D.DEPTNO=E.DEPTNO

AND D.DNAME IN (:DEPARTMENT)

ORDER BY D.DNAME

This statement includes an extra filter condition: D.DNAME IN (:DEPARTMENT). This contains a parameter placeholder (:DEPARTMENT) for which one or more values must be specified before the SQL statement can be executed. The user will be requested to enter a suitable value or values when the statement is invoked.

If, for example, the user enters the value “SALES”, then the query generator software modifies the statement by substituting this value in place of the (:DEPARTMENT) parameter placeholder to create the following statement:

SELECT D.DNAME, E.EMPNO, E.ENAME, E.SAL

FROM DEPT D, EMP E

WHERE D.DEPTNO=E.DEPTNO

AND D.DNAME IN (‘SALES’)

ORDER BY D.DNAME

This modified query only retrieves values which match the specified department value, i.e. SALES. Thus, the following data are returned:

Department: Sales

| EMPNO | ENAME | SAL |
|---|---|---|
| 7499 | ALLEN | 1600 |
| 7521 | WARD | 1250 |
| 7654 | MARTIN | 1250 |
| 7698 | BLAKE | 2850 |
| 7844 | TURNER | 1500 |
| 7900 | JAMES | 950 |
| | Total: | 9400 |

However, the approach taken in this invention is to allow each Department Manager (or indeed any other user) to specify a user-settable filter. For example, the Manager of the Accounts Department (for which the value of DNAME=‘Accounting’) could create and enable a user-settable filter “DNAME=‘Accounting’”. Whenever the Department Manager ran either of the base reports, the reporting system would: recognise the presence of the user-settable filter; determine that the user-settable filter is applicable (i.e. by recognising that the query contains a reference to the DEPT table); and apply the filter to the reports SQL statement.

As such, if this Manager having set the filter described above ran the sales by department report, the resulting SQL statement would be:

SELECT D.DNAME, S.CUSTOMER, S.SALE_DATE S.SALE_AMOUNT,

S.SALES_EMPNO

FROM DEPT D, EMP E, SALES S

WHERE D.DEPTNO=E.DEPTNO

AND S.SALES_EMPNO=E.EMPNO

AND DNAME=‘Accounting’

As can be seen, an additional condition that DNAME=‘Accounting’ has been added at the end of this SQL statement which has the effect of filtering the retrieved results such that only the following table is returned, and this can be contrasted with the pair of tables that were returned when the same report was run by the CEO who did not apply the filter.

| CUS- | | | |
|---|---|---|---|
| TOMER | SALE_DATE | SALE_AMOUNT | SALES_EMPNO |
| Foo | 1 Feb. 2000 | 2000 | 7782 |
| | Total: | 2000 | |

In order to achieve this the query generator software allows users to specify default filters which are to be applied when an associated criterion is satisfied. For example, in this case the criterion is that a specific table is referred to and the query is run by a specific user. Thus, the query generator stores a list of the criteria and associated filters, typically as a table in a database, called USER_DEFAULT_FILTERS for example. For example, the table may contain the following rows:

| | USER | TABLE | DEFAULT_FILTER |
|---|---|---|---|
| 1 | A | DEPT | DNAME = ‘Accounting’ |
| 2 | B | DEPT | DNAME = ‘Sales’ |
| 3 | A | SALESCUST | OMER = ‘Star Corp’ |

This table specifies three default filters to be applied when the associated criterion is met. For example, filter 1 is applied when a query is run by user A (e.g. the accounting manager) and the query refers to table DEPT. In this case, the applied filter ensures that only data where DNAME=‘Accounting’ are returned by the query.

Once this table has been defined, it can be used to determine whether a default filter should be applied for each query that is then run. An example will now be described with reference to FIG. 3, which shows a flow chart of the method performed by the query generator software. In this example, user B runs the report defined by the following SQL statement:

SELECT D.DNAME, S.CUSTOMER, S.SALE_DATE, S.SALE_AMOUNT,

S.SALES_EMPNO

FROM DEPT D, EMP E, SALES S

WHERE D.DEPTNO=E.DEPTNO

AND S.SALES_EMPNO=E.EMPNO

ORDER BY D.DNAME

This SQL statement is retrieved by the query generator software in step 10. Before the query generator software executes this report, it will analyse the USER_DEFAULT_FILTERS table in step 11 to see whether any of the default filters should be applied. To do this the software extracts the list of tables referred to by the query (DEPT, EMP and SALES) and, for each of these tables, it queries the USER_DEFAULT_FILTERS table filtering the returned data by the current user (User B) and the name of the table (e.g. DEPT). In this case, the criterion that User B is running the report and that the DEPT table is referred to is met. Thus, in step 12, the filtered data retrieved by querying the USER_DEFAULT FILTERS table returns the second row and the default filter condition: DNAME=‘Sales’ will be extracted.

The report's SQL statement is then modified, in step 13, to incorporate this default filter condition to generate the following statement:

SELECT D.DNAME, S.CUSTOMER, S.SALE_DATE, S.SALE_AMOUNT,

S.SALES_EMPNO

FROM DEPT D, EMP E, SALES S

WHERE D.DEPTNO=E.DEPTNO

AND S.SALES_EMPNO=E.EMPNO

AND DNAME=‘Sales’

ORDER BY D.DNAME

This modified statement is then executed, in step 14, to return the following results:

Department: Sales

| CUS- | | | |
|---|---|---|---|
| TOMER | SALE_DATES | SALE_AMOUNT | SALES_EMPNO |
| Bar | 5 Mar. 2000 | 3000 | 7900 |
| Star Corp | 10 Jan. 2001 | 6000 | 7900 |
| Star Corp | 20 Jun. 2001 | 5000 | 7900 |
| Bar | 11 Jul. 2001 | 3400 | 7900 |
| | Total: | 17400 | |

It is possible for the user to disable the application of the default filter should he wish. For example, this may be an option that the user can select when viewing the report's output in which case the report is rerun without the default filter being applied and the user will then see the data for all departments.

The invention allows for a single base report to be adapted such that it can be used by a variety of users by allowing them to specify a user-settable filter when the report is run.

Although the embodiment of this invention has been described with reference to the tables and columns stored in a database, it will be apparent to those skilled in the art that the invention may operate on metadata layers constructed on top of the database.

The embodiment has been described in the context of application of default filters based applied on the basis of the identity of a currently authenticated user. The context in which it operates however is arbitrary. For example, the database may contain data relating to geographical location (for example, sales by geographical region) and the invention may detect the geographical location of a user and filter the results according to that location (for example, only returning data relevant to sales in the UK). Alternatively, the context may be the time that the query is actually executed on a database. For example, the database may contain diary information specifying tasks for a user to do on different days, but the default filtering may ensure that only data relevant to the particular day that the query is executed are returned.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROMs, as well as transmission-type media, such as digital and analog communications links.

1. A query generator for generating a query for retrieving a desired set of data from a relational database, wherein the query generator is adapted to:
a) receive an input query adapted to retrieve a superset of the desired set of data from the database;
b) analyse a default filters table comprising one or more filter application criteria, each associated with a default filter condition that refers to data contained in the superset of data; and
c) for each filter application criterion that is satisfied, modify the input query in accordance with the associated default filter condition to produce an output query adapted to retrieve the desired set of data only.

2. A query generator according to claim 1, wherein the query generator is further adapted to execute the output query on the database, thereby retrieving the desired set of data.

3. A query generator according to claim 1, wherein the input query is a structured query language (SQL) query.

4. A query generator according to claim 1, wherein the output query is a structured query language (SQL) query.

5. A query generator according to claim 1, wherein the desired set of data is stored in more than one table in the database.

6. A query generator according to claim 1, wherein the default filters table is stored in the database.

7. A query generator according to claim 1, wherein the filter application criteria include the identification of a user.

8. A query generator according to claim 1, wherein the filter application criteria include the geographical location of a user.

9. A query generator according to claim 1, wherein the filter application criteria include the time of execution of the query.

10. A query generator according to claim 1, wherein the desired set of data includes rows from one or more of the database tables containing data specified by the associated default filter condition.

11. A method for generating a query for retrieving a desired set of data from a relational database, the method comprising:
a) receiving an input query adapted to retrieve a superset of the desired set of data from the database;
b) analysing a default filters table comprising one or more filter application criteria, each associated with a default filter condition that refers to data contained in the superset of data; and
c) for each filter application criteria that is satisfied, modifying the input query in accordance with the default filter condition to produce an output query adapted to retrieve the desired set of data only.

12. A method according to claim 11, wherein the method further comprises executing the output query on the database, thereby retrieving the desired set of data.

13. A method according to claim 11, wherein the input query is a structured query language (SQL) query.

14. A method according to claims 11, wherein the output query is a structured query language (SQL) query.

15. A method according to any of claims 11, wherein the desired set of data is stored in more than one table in the database.

16. A query generator according to any of claims 11, wherein the default filters table is stored in the database.

17. A query generator according to any of claims 11, wherein the filter application criteria include the identification of a user.

18. A query generator according to any of claims 11, wherein the filter application criteria include the geographical location of a user.

19. A query generator according to any of claims 11, wherein the filter application criteria include the time of execution of the query.

20. A query generator according to any of claims 11, wherein the desired set of data includes rows from one or more of the database tables containing data specified by the associated default filter condition.

21. A computer program comprising computer program code means adapted to perform the method of any of claims 11 when said program is run on a computer.

22. A computer program product comprising program code means stored on a computer readable medium for performing the method of any of claims 11 when said program is run on a computer.
